(19) United States
(12) Patent Application Publication
(10) Pub. No.: US 2025/0078794 A1
(43) Pub. Date: Mar. 6, 2025

(54) DETECTION SYSTEM AND MUSICAL INSTRUMENT

(71) Applicant: YAMAHA CORPORATION, Hamamatsu-shi (JP)

(72) Inventors: Kazuyuki IGARASHI, Tokyo (JP); Akihiko KOMATSU, Hamamatsu-shi (JP)

(21) Appl. No.: 18/953,380

(22) Filed: Nov. 20, 2024

Related U.S. Application Data
(63) Continuation of application No. PCT/JP2023/017583, filed on May 10, 2023.

(30) Foreign Application Priority Data
May 24, 2022 (JP) 2022-084802

(51) Int. Cl. G10H 1/34; G10H 1/00

(52) U.S. Cl. CPC G10H 1/344; G10H 1/0016

(57) ABSTRACT

A first detection signal is generated based on a distance between a first detectable coil disposed on a first key and a first drive coil. A second detection signal is generated based on a distance between a second detectable coil disposed on a second key and a second drive coil. The first drive coil includes first and second drivers through which current flows in a first direction and in a second direction opposite to the first direction, respectively. The second drive coil includes third and fourth drivers through which current flows in the first direction. The first detectable coil includes first and second portions in which induction currents in opposite directions are generated by electromagnetic induction of the first drive coil. The second detectable coil includes third and fourth portions in which induction currents in the same direction are generated by electromagnetic induction of the second drive coil.

### CROSS REFERENCE TO RELATED APPLICATION

This application is a Continuation Application of PCT Application No. PCT/JP2023/017583 filed on May 10, 2023, and is based on and claims priority from Japanese Patent Application No. 2022-084802 filed on May 24, 2022, the entire contents of each of which are incorporated herein by reference.

### TECHNICAL FIELD

The present disclosure relates to techniques for detecting a position of a movable member.

### BACKGROUND

Various techniques for detecting a position of a movable member have been proposed. For example, WO 2019/122867 discloses a detection system including an active resonant circuit disposed on a main body of a keyboard musical instrument that has a plurality of keys with a passive resonant circuit disposed on each of the plurality of the keys. The active resonant circuit includes a coil that upon supply of a periodic signal generates a magnetic field to generate a detection signal based on a distance between the coil of the active resonant circuit and a coil of a passive resonance circuit.

In WO 2019/122867, a magnetic field generated by the coil of the active resonant circuit corresponding to one of the plurality of the keys interacts with the coil of the passive resonant circuit of another key adjacent to the one of the plurality of the keys. Such interactions between adjacent keys of the plurality of the keys can impede highly accurate detection of positions of adjacent keys. Key detection in a keyboard musical instrument is one example, but a similar issue arises in other configurations in which multiple movable members are similarly provided in close proximity to each other.

### SUMMARY

In view of the above circumstances, an object of one aspect of the present disclosure is to detect with high accuracy a position of each of a plurality of movable members.

To achieve the object, a detection system according to one aspect of the present disclosure includes: a first detectable coil disposed on a first movable member; a second detectable coil disposed on a second movable member; a first signal generator, including a first drive coil that faces the first detectable coil, configured to generate a first detection signal based on a distance between the first detectable coil and the first drive coil; and a second signal generator, including a second drive coil that faces the second detectable coil, configured to generate a second detection signal based on a distance between the second detectable coil and the second drive coil. The first drive coil includes: a first driver through which current flows in a first direction; and a second driver through which current flows in a second direction opposite to the first direction, the second drive coil includes: a third driver through which current flows in the first direction; and a fourth driver through which current flows in the first direction, the first detectable coil includes a first portion and a second portion where induced currents in directions opposite to each other are generated by electromagnetic induction of the first drive coil, and the second detectable coil includes a third portion and a fourth portion where induced currents in a same direction as each other are generated by electromagnetic induction of the second drive coil.

A musical instrument according to one aspect of the present disclosure includes a first movable member and a second movable member that move in response to a playing operation of a user; a first detectable coil disposed on the first movable member; a second detectable coil disposed on the second movable member; a first signal generator, including a first drive coil that faces the first detectable coil, configured to generate a first detection signal based on a distance between the first detectable coil and the first drive coil; and a second signal generator, including a second drive coil that faces the second detectable coil, configured to generate a second detection signal based on a distance between the second detectable coil and the second drive coil. The first drive coil includes: a first driver through which current flows in a first direction; and a second driver through which current flows in a second direction opposite to the first direction. The second drive coil includes: a third driver through which current flows in the first direction; and a fourth driver through which current flows in the first direction. The first detectable coil includes a first portion and a second portion where induced currents in directions opposite to each other are generated by electromagnetic induction of the first drive coil, and the second detectable coil includes a third portion and a fourth portion where induced currents in a same direction as each other are generated by electromagnetic induction of the second drive coil.

### BRIEF DESCRIPTION OF THE DRAWINGS

FIG. 1 is a block diagram illustrating a configuration of a keyboard musical instrument according to a first embodiment.

FIG. 2 is a schematic diagram illustrating a configuration of a keyboard musical instrument.

FIG. 3 is a circuit diagram of a signal generator and a detectable portion.

FIG. 4 is a block diagram illustrating a configuration of a drive circuit.

FIG. 5 is a flowchart of control processing.

FIG. 6 is a schematic diagram of a correlation table.

FIG. 7 is a schematic diagram of the signal generator and the detectable portion.

FIG. 8 is a plan view of the first signal generator.

FIG. 9 is a cross-sectional view taken along line a-a in FIG. 8.

FIG. 10 is a plan view of a second signal generator.

FIG. 11 is a cross-sectional view taken along line b-b in FIG. 10.

FIG. 12 is a plan view of a first detectable portion.

FIG. 13 is a cross-sectional view taken along line c-c in FIG. 12.

FIG. 14 is a plan view of a second detectable portion.

FIG. 15 is a cross-sectional view taken along line d-d in FIG. 14.

FIG. 16 is a diagram explaining an operation of a detection system.

FIG. 17 shows a relationship between a position of a key and a signal level of a detection signal.

FIG. 18 is a diagram explaining samples in FIG. 17.

FIG. 19 shows a relationship between a position of a key and a signal level of a detection signal.

FIG. 20 is a diagram explaining samples in FIG. 19.

FIG. 21 is a diagram explaining an operation of a detection system according to a second embodiment.

FIG. 22 is a schematic diagram of correlation tables according to a third embodiment.

FIG. 23 is a diagram explaining a difference in position-level characteristics between a first key and a second key.

FIG. 24 is a plan view of a first detectable portion according to a fourth embodiment.

FIG. 25 is a plan view of a second detectable portion according to a modification of the fourth embodiment.

FIG. 26 is a schematic diagram of a striking mechanism according to a modification.

FIG. 27 is a schematic diagram of a pedal mechanism according to a modification.

### DETAILED DESCRIPTION

### A: First Embodiment

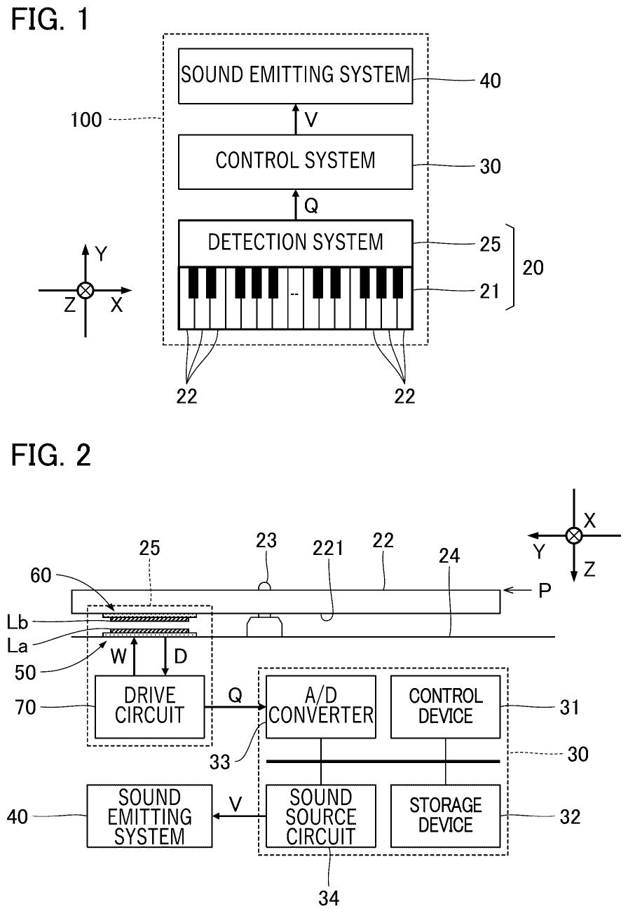

FIG. 1 is a block diagram illustrating a configuration of a keyboard musical instrument 100 according to a first embodiment of the present disclosure. The keyboard musical instrument 100 is an electronic musical instrument including a keyboard unit 20, a control system 30, and a sound emitting system 40. In the following description, three orthogonal axes, respectively denoted X, Y and Z are referenced. The X-axis is a left/right axis (horizontal direction) of the keyboard musical instrument 100, and the Y-axis is a front/rear axis (depth direction) of the keyboard musical instrument 100. Thus, a plane XY is parallel to a horizontal plane. The Z axis is an up/down axis (vertical direction) of the keyboard musical instrument 100. The direction of the X-axis is an example of a “specific direction.”

The keyboard unit 20 is an input device, and includes a keyboard 21 and a detection system 25. The keyboard 21 is a keyboard used for playing by a user, and includes a plurality of keys 22 each of which corresponds to a different music pitch. The plurality of the keys 22 includes a plurality of white keys and a plurality of black keys arranged in the X-axis direction. Each of the plurality of the keys 22 is a movable member that is elongate in the Y-axis direction, and, when subject to a playing operation by the user, moves in the Z-axis direction. The playing operation by the user involves pressing or releasing one or more of the plurality of the keys 22. The detection system 25 detects a position P of each of the plurality of the keys 22 in the Z-axis direction.

The control system 30 generates an audio signal V based on a detection result of the detection system 25. The audio signal V is a signal that represents a music sound with a pitch corresponding to one of the plurality of the keys 22 that is subject to a playing operation by the user. The control system 30 may be configured separately from the keyboard musical instrument 100. For example, a general-purpose information processing apparatus such as a smartphone, a tablet terminal, or a personal computer may be used as the control system 30.

The sound emitting system 40 emits a music sound represented by the audio signal V. For example, one or more speakers or headphones (earphones) that are worn on the user's head may be used as the sound emitting system 40. The sound emitting system 40 may be provided separate from and be connectable to the keyboard musical instrument 100 either by wire or wirelessly.

FIG. 2 is a schematic diagram illustrating a configuration of the keyboard musical instrument 100. Each of the plurality of the keys 22 of the keyboard 21 is supported by a support 24 and has a balance pin 23 that acts as a pivot point. The support 24 is a structure that supports each element of the keyboard musical instrument 100. A distal end portion of each of the plurality of the keys 22 moves in the Z-axis direction in response to the playing operation of the user. The detection system 25 generates an observation signal Q that represents the position P for each of the plurality of the keys 22. The position P is, for example, a surface position on the distal end portion of each of the plurality of the keys 22. The position P is expressed by, for example, a movement amount relative to each of the plurality of the keys 22 not subject to a playing operation by the user.

The detection system 25 includes a plurality of signal generators 50, a plurality of detectable portions 60, and a drive circuit 70. One of the plurality of the signal generators 50 and one of the plurality of the detectable portions 60 are installed for each of the plurality of the keys 22. Each of the plurality of the signal generators 50 is provided at a fixed position on the support 24. A detectable portion 60 is provided on each of the plurality of the keys 22. More specifically, the detectable portion 60 is disposed on a bottom surface 221 of each of the plurality of the keys 22. The position of the detectable portion 60 in the Z-axis direction changes in accordance with a playing operation of the user.

The signal generator 50 includes a drive coil La. The detectable portion 60 includes a detectable coil Lb. The drive coil La and the detectable coil Lb face each other with a space therebetween in the Z-axis direction. The distance between the signal generator 50 and the detectable portion 60 (the distance between the drive coil La and the detectable coil Lb) varies depending on a position P of a corresponding key 22. In the first embodiment, the detectable portion 60 is disposed between a rear end portion of each of the plurality of the keys 22 and the corresponding balance pin 23. Consequently, the distance between the drive coil La and the detectable coil Lb is increased when one of the plurality of the keys 22 is pressed by the user. The drive circuit 70 generates an observation signal Q with a signal level corresponding to a distance between the drive coil La and the detectable coil Lb.

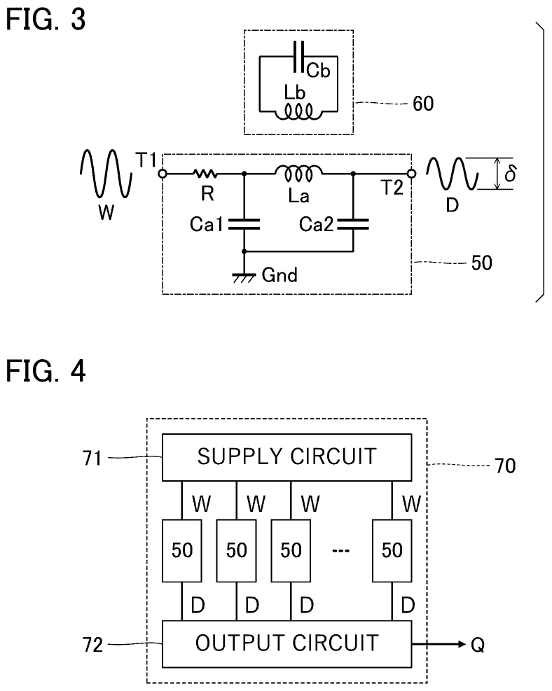

FIG. 3 is a circuit diagram showing an example of an electrical configuration of the signal generator 50 and the detectable portion 60 corresponding to any one of the plurality of the keys 22. The signal generator 50 is a resonant circuit that includes an input terminal T1, an output terminal T2, a resistive element R, a drive coil La, a capacitive element Ca1, and a capacitive element Ca2. One end of the resistive element R is connected to the input terminal T1, and the other end of the resistive element R is connected to one end of the capacitive element Ca1 and one end of the drive coil La. The other end of the drive coil La is connected to the output terminal T2 and one end of the capacitive element Ca2. The other end of the capacitive element Ca1 and the other end of the capacitive element Ca2 are grounded (Gnd).

The detectable portion 60 is a resonant circuit including a detectable coil Lb and a capacitive element Cb. One end of the detectable coil Lb and one end of the capacitive element Cb are connected to each other, and the other end of the detectable coil Lb and the other end of the capacitive element Cb are connected to each other. In the first embodiment, the resonance frequency of the signal generator 50 and the resonance frequency of the detectable portion 60 are configured to be equal to each other. However, the resonance frequency of the signal generator 50 may be configured to be different from the resonance frequency of the detectable portion 60. For example, the resonance frequency of the signal generator 50 may be set at a frequency obtained by multiplying the resonance frequency of the detectable portion 60 by a predetermined constant.

FIG. 4 is a block diagram illustrating an example configuration of the drive circuit 70. The drive circuit 70 includes a supply circuit 71 and an output circuit 72. The supply circuit 71 supplies a drive signal W to respective input terminals T1 of the plurality of the signal generators 50. For example, the supply circuit 71 is a demultiplexer that supplies the drive signal W to each of the plurality of signal generators 50 in a time-division manner for a predetermined period (hereinafter, a “drive period”). A level of the drive signal W changes periodically. For example, a periodic signal of a freely selected waveform such as a sine wave or a square wave is used as the drive signal W. The period of the drive signal W is sufficiently shorter than the length of a drive period during which the drive signal W is supplied to each of the plurality of signal generators 50. A frequency of the drive signal W is set at a frequency that is substantially equal to the resonance frequency of the signal generator 50 and the detectable portion 60.

The drive signal W is supplied to the drive coil La through the input terminal T1 and the resistive element R. A magnetic field is generated in the drive coil La by supply of the drive signal W. An induced current is generated in the detectable coil Lb of the detectable portion 60 through electromagnetic induction caused by the magnetic field generated by the drive coil La. That is, a magnetic field that cancels a change in the magnetic field in the drive coil La is generated by the detectable coil Lb. The magnetic field generated by the detectable coil Lb varies depending on a distance between the drive coil La and the detectable coil Lb. As a result, a detection signal D having an amplitude δ corresponding to a distance between the drive coil La and the detectable coil Lb is output from the output terminal T2. The detection signal D is a periodic signal having a frequency equivalent to that of the drive signal W. The amplitude δ of the detection signal D varies depending on a position P of the one of the plurality of keys 22.

The output circuit 72 in FIG. 4 is a multiplexer that generates an observation signal Q by arranging on a time axis detection signals D output from each of the plurality of the signal generators 50 for each of respective drive periods. Specifically, the output circuit 72 rectifies (full-wave rectification or half-wave rectification) and smoothes a detection signal D output from each of the signal generators 50 during a corresponding drive period, and arranges on the time axis the smoothed signals in the respective drive periods to generate the observation signal Q. As will be understood from the above description, the signal level of the observation signal Q is set based on the position P of one of the plurality of the keys 22 for each drive period. Specifically, the signal level of the observation signal Q increases as the drive coil La and the detectable coil Lb move apart from each other. The signal level of the observation signal Q in a drive period corresponds to a signal level of a detection signal D generated by the signal generator 50 during the drive period.

The control system 30 in FIG. 2 determines the position P of the any one of the plurality of the corresponding keys 22 by analyzing the observation signal Q supplied from the drive circuit 70. The control system 30 is implemented by a computer system that includes a control device 31, a storage device 32, an A/D converter 33, and a sound source circuit 34. The control system 30 may be realized not only by a single apparatus but also by a plurality of apparatuses configured separately from each other.

The control device 31 includes one or more processors that control each element of the keyboard musical instrument 100. Specifically, the control device 31 is configured of one or more types of processors such as CPU (Central Processing Unit), GPU (Graphics Processing Unit), SPU (Sound Processing Unit), DSP (Digital Signal Processor), FPGA (Field Programmable Gate Array), or ASIC (Application Specific Integrated Circuit).

The storage device 32 comprises one or a plurality of memories that stores programs executed by the control device 31 and data used by the control device 31. The storage device 32 comprises a known recording medium, such as a magnetic recording medium or a semiconductor recording medium. The storage device 32 may be constituted of a combination of a plurality of types of recording media. The storage device 32 may be a portable recording medium that is detachable from the keyboard musical instrument 100 or an external recording medium (for example, online storage) with which the keyboard musical instrument 100 is communicable.

The A/D converter 33 converts an observation signal Q supplied from the drive circuit 70 from analog format to digital format. The sound source circuit 34 generates an audio signal V that represents a music sound indicated by the control device 31. Specifically, the generated audio signal V represents a music sound with a pitch that corresponds to one of the plurality of the keys 22 for which the position P has changed. The volume of the audio signal V is controlled in accordance with, for example, a velocity of change of the position P. When the audio signal V is supplied from the sound source circuit 34 to the sound emitting system 40, the music sound corresponding to the playing operation of the user is emitted from the sound emitting system 40. The control device 31 realizes the function of the sound source circuit 34 by executing a program stored in the storage device 32. An element for generating audio signals V (a sound source) may be any one of a software sound source realized by the general-purpose control device 31 and a hardware sound source realized by a dedicated electronic circuit.

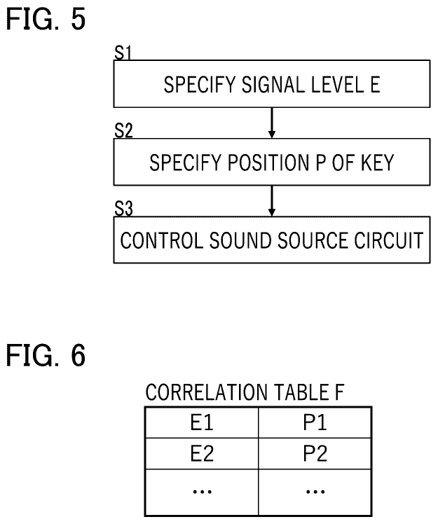

FIG. 5 is a flowchart showing processing executed by the control device 31 (hereinafter, “control processing”). For example, the control processing is repeated for each drive period. That is, the control processing shown in FIG. 5 is executed for each of the plurality of the keys 22. When the control processing starts, the control device 31 specifies a signal level E for each of the detection signals D based on the observation signal Q converted by the A/D converter 33 (S1). The signal level E in each drive period is a voltage value that corresponds to an amplitude 8 of a corresponding detection signal D generated by the signal generator 50 in each drive period. That is, the signal level E is set to a voltage value corresponding to the position P of one of the plurality of the keys 22 that corresponds to the drive period.

The control device 31 specifies a position P of each of the plurality of the keys 22 from the corresponding signal level E (S2). The position P of each of the plurality of the keys 22 is analyzed by use, for example, of a correlation table F shown in FIG. 6. The correlation table F is a data table in which the position P (P1, P2, . . . ) of each of the plurality of the keys 22 is set for each of a plurality of possible numerical values (E1, E2, . . . ) of the signal level E of the corresponding detection signal D (observation signal Q). The control device 31 searches the correlation table F for a signal level E specified based on the observation signal Q, and specifies, as the position P of each of the plurality of the keys 22, a position P that corresponds to the signal level E among a plurality of positions P. The control device 31 may calculate the position P by using a predetermined calculation in which a signal level E is applied. As will be understood from the above description, the control device 31 functions as an element (position analyzer) that specifies the position P of each of the plurality of the keys 22 from a signal level E of a corresponding detection signal D.

The control device 31 controls the sound source circuit 34 in accordance with the position P of each of the plurality of the keys 22 (S3). Specifically, the control device 31 determines whether one of the plurality of the keys 22 has been pressed by the user in accordance with the position P of each of the plurality of the keys 22, and instructs the sound source circuit 34 to produce a music sound corresponding to the one of the keys 22 that is determined to have been pressed by the user. The sound source circuit 34 generates an audio signal V that represents the music sound indicated by the control device 31.

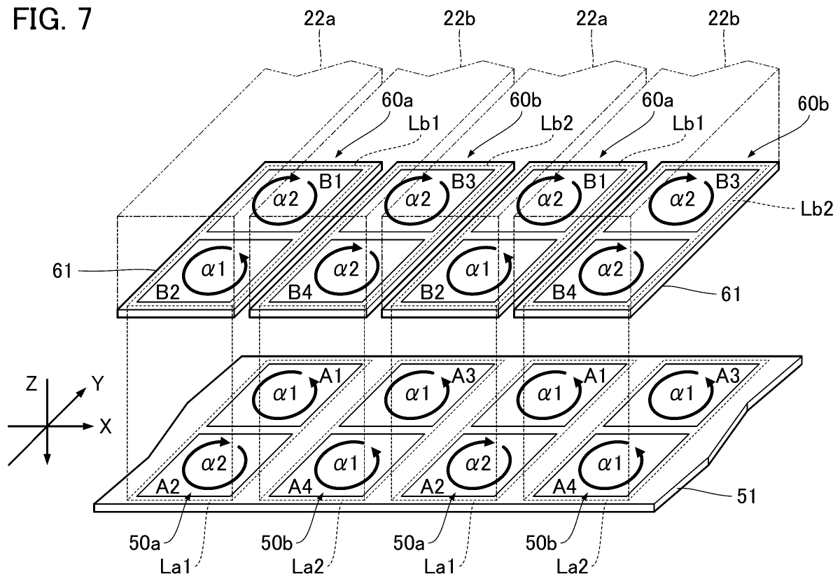

FIG. 7 is a schematic diagram of signal generators 50 and detectable portions 60. The broken line in the vertical direction in FIG. 7 indicates a positional correspondence between each of the signal generators 50 and a corresponding detectable portion 60 of the detectable portions 60 (the detectable portion 60 is positioned directly above the signal generator 50).

The plurality of the keys 22 constituting the keyboard 21 is grouped into first keys 22a and second keys 22b. The first keys and the second keys are each adjacent to each other. For example, of the plurality of the keys 22, odd-numbered keys 22 correspond to the first keys 22a, and even-numbered keys 22 correspond to the second keys 22b. The first keys 22a and the second keys 22b are alternately arranged along the X-axis. The first keys 22a are each an example of a “first movable member,” and the second keys 22b are each an example of the “second movable member.” In FIG. 7, for convenience, the plurality of keys 22 is illustrated as having the same shape. However, an actual shape of the white keys differs from an actual shape of the black keys.

The plurality of signal generators 50 includes a plurality of first signal generators 50a and a plurality of second signal generators 50b. The plurality of the first signal generators 50a corresponds to the plurality of the first keys 22a, and the plurality of the second signal generators 50b corresponds to the plurality of the second keys 22b. More specifically, for example, among the plurality of signal generators 50 arranged in the X-axis direction, the odd-numbered signal generators 50 are first signal generators 50a, and the even-numbered signal generators 50 are second signal generators 50b. Consequently, the first signal generators 50a and the second signal generators 50b are alternately arranged along the X-axis.

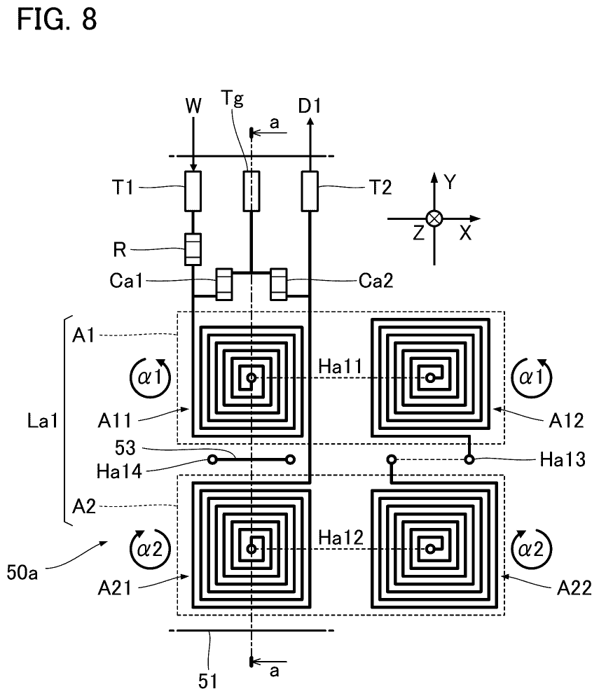

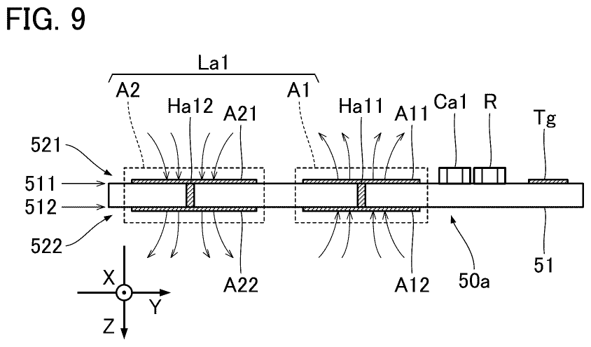

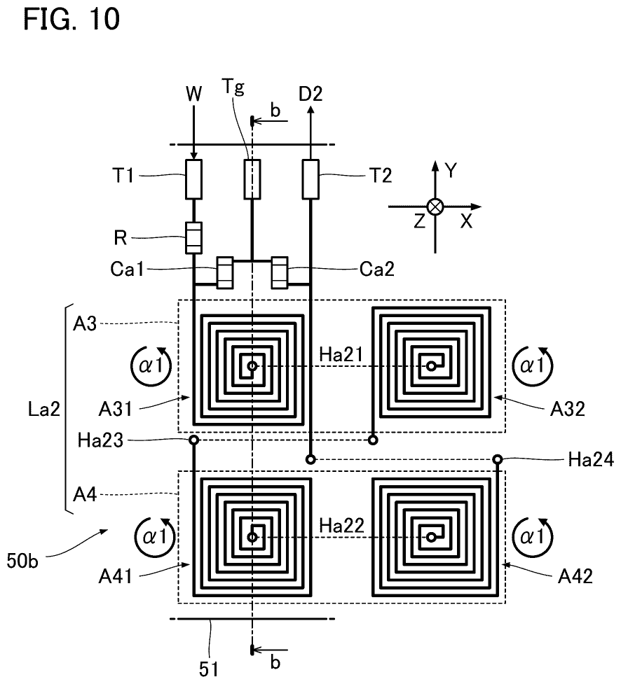

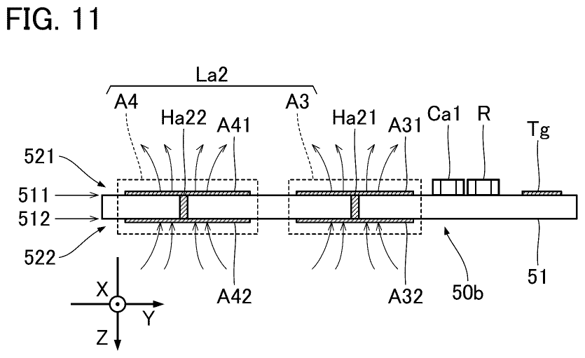

FIG. 8 is a plan view of one of the first signal generators 50a in the positive direction of the Z-axis, and FIG. 9 is a cross-sectional view taken along line a-a in FIG. 8. FIG. 10 is a plan view of one of the second signal generators 50b in the positive direction of the Z-axis, and FIG. 11 is a cross-sectional view taken along line b-b in FIG. 10.

As illustrated in FIGS. 9 and 11, the signal generators 50 (the first signal generators 50a and the second signal generators 50b) are disposed on a base member 51. The base member 51 is a rigid insulating board, for example. Specifically, as illustrated in FIG. 7, the base member 51 is a plate-shaped member that is elongate in the X-axis direction over the plurality of the signal generators 50. As illustrated in FIGS. 9 and 11, the base member 51 includes a first surface 511 and a second surface 512. The first surface 511 and the second surface 512 are in opposing relation to each other. The first surface 511 is a surface of the base member 51 facing the detectable portion 60, and the second surface 512 is a surface of the base member 51 facing the support 24. Mounted on the first surface 511 are a resistive element R, a capacitive element Ca1, and a capacitive element Ca2 for each of the signal generators 50. The base member 51 may otherwise be comprised of a flexible insulating film, for example.

Formed on the first surface 511 of the base member 51 is a conductive pattern 521. The conductive pattern 521 may be formed by patterning a conductive film over the entire area of the first surface 511, for example. The conductive pattern 521 includes an input terminal T1, an output terminal T2, and a ground terminal Tg for each of the plurality of the signal generators 50. Formed on the second surface 512 of the base member 51 is a conductive pattern 522. The conductive pattern 522 may be formed by patterning a conductive film over the entire area of the second surface 512, for example. The configuration of each of the first signal generators 50a and the second signal generators 50b is described below.

### First Signal Generator 50a

As illustrated in FIGS. 8 and 9, each of the first signal generators 50a includes a first drive coil La1 as the drive coil La shown in FIG. 3. The first drive coil La1 includes a first driver A1 and a second driver A2. The first driver A1 and the second driver A2 are aligned in the Y-axis direction (in the longitudinal direction of each of the plurality of the keys 22). Specifically, the first driver A1 is positioned in the positive direction of the Y-axis as viewed from the second driver A2.

The first driver A1 is comprised of a stack made up of a wound portion A11 and a wound portion A12. The second driver A2 is comprised of a stack made up of a wound portion A21 and a wound portion A22. The wound portion A11 and the wound portion A21 are included in the conductive pattern 521 on the first surface 511. The wound portion A11 and the wound portion A21 are each in a shape of a spiral that turns clockwise from an inner circumference to an outer circumference as viewed in the positive direction of the Z-axis. The wound portion A12 and the wound portion A22 are included in the conductive pattern 522 on the second surface 512, and are each in a shape of a spiral that turns counterclockwise from the inner circumference to the outer circumference as viewed in the positive direction of the Z-axis. The center of the wound portion A11 and the center of the wound portion A12 are electrically connected to each other via a conductive through-hole Ha11. Similarly, the center of the wound portion A21 and the center of the wound portion A22 are electrically connected to each other via a conductive though-hole Ha12. Each conductive through-hole Ha (Ha11, Ha12, Ha13, Ha14, Ha21, Ha22, Ha23, Ha24) is a through hole formed in the base member 51.

The wound portion A11 is connected to the input terminal T1 via the resistive element R, and the wound portion A21 is connected to the output terminal T2. Further, a capacitive element Ca1 is provided between the resistive element R and a ground terminal Tg; and a capacitive element Ca2 is provided between the output terminal T2 and the ground terminal Tg.

The first signal generator 50a includes a wire 53 in the conductive pattern 521. The wound portion A12 of the first driver A1 is electrically connected to one end of the wire 53 via a conductive through-hole Ha13, and the wound portion A22 of the second driver A2 is electrically connected to the other end of the wire 53 via a conductive through-hole Ha14. That is, the wound portion A12 and the wound portion A22 are electrically connected by the wire 53.

As will be understood from FIG. 8, when a current flows in the first direction α1 in the wound portion A11, a current also flows in the first direction α1 in the wound portion A12. When the current flows in the first direction α1 in the wound portion A11, a current also flows in the second direction α2, which is opposite to the first direction α1, in both the wound portion A21 and the wound portion A22. That is, the current that flows in the first direction α1 flows through the first driver A1, and the current that flows in the second direction α2 flows through the second driver A2. Therefore, when a drive signal W is supplied to the first drive coil La1, as illustrated in FIG. 9, magnetic fields opposite to each other are generated respectively in the first driver A1 and the second driver A2. Since the drive signal W is a signal with a signal level that is periodically inverted, each of the first direction α1 and the second direction α2 is periodically inverted, for example, while maintaining a mutually opposite relationship.

### Second Signal Generator 50b

As illustrated in FIGS. 10 and 11, the second signal generator 50b includes a second drive coil La2 as the drive coil La shown in FIG. 3. The second drive coil La2 includes a third driver A3 and a fourth driver A4. The third driver A3 and the fourth driver A4 are aligned along the Y-axis direction (i.e., the longitudinal direction each of the plurality of the keys 22). The third driver A3 is in the positive direction of the Y-axis as viewed from the fourth driver A4.

The third driver A3 is comprised of a stack made up of the wound portion A31 and the wound portion A32. The fourth driver A4 is comprised of a stack made up of the wound portion A41 and the wound portion A42. The wound portion A31 and the wound portion A41 are included in the conductive pattern 521 of the first surface 511. The wound portion A31 and the wound portion A41 are each in a shape of a spiral that turns clockwise from the inner circumference to the outer circumference as viewed in the positive direction of the Z-axis. The wound portion A32 and the wound portion A42 are included in the conductive pattern 522 of the second surface 512, and are each in a shape of a spiral that turns counterclockwise from the inner circumference to the outer circumference as viewed in the positive direction of the Z-axis. The center of the wound portion A31 and the center of the wound portion A32 are electrically connected to each other via the conductive through-hole Ha21. Similarly, the center of the wound portion A41 and the center of the wound portion A42 are electrically connected to each other via the conductive through-hole Ha22.

The wound portion A31 is connected to the input terminal T1 via the resistive element R. A capacitive element Ca1 is provided between the resistive element R and the ground terminal Tg; and a capacitive element Ca2 is provided between the output terminal T2 and the ground terminal Tg. Further, the wound portion A41 is electrically connected to the wound portion A32 via the conductive through-hole Ha23; and the wound portion A42 is electrically connected to the output terminal T2 via the conductive through-hole Ha24.

As will be understood from FIG. 10, when the current flows in the first direction α1 in the wound portion A31, the current also flows in the first direction α1 in the wound portion A32. When a current flows in the first direction α1 in the wound portion A31, a current also flows in the first direction α1 in both the wound portion A41 and the wound portion A42. That is, the current flows in the first direction α1 in both the third driver A3 and the fourth driver A4. Therefore, when the drive signal W is supplied to the second drive coil La2, as illustrated in FIG. 11, magnetic fields in the same direction are generated respectively in the third driver A3 and the fourth driver A4. Since the drive signal W is a signal with a signal level that is periodically inverted, each of the first direction α1 and the second direction α2 is also periodically inverted, for example, while maintaining the same relationship with each other.

As described above, the first signal generator 50a includes the first driver A1 and the second driver A2 in which currents flow in opposite directions; and the second signal generator 50b includes the third driver A3 and the fourth driver A4 in which currents flow in the same direction.

As illustrated in FIG. 7, the plurality of the detectable portions 60 includes a plurality of first detectable portions 60a and a plurality of second detectable portions 60b. The plurality of the first detectable portions 60a corresponds to the plurality of the first keys 22a; and the plurality of the second detectable portions 60b corresponds to the plurality of the second keys 22b. Specifically, the plurality of the first detectable portions 60a is disposed on the bottom surface 221 of each of the plurality of the first keys 22a; and the plurality of the second detectable portions 60b is disposed on the bottom surface 221 of each of the plurality of the second keys 22b. That is, the odd-numbered detectable portions 60 are the first detectable portions 60a, and the even-numbered detectable portions 60 are the second detectable portions 60b. Accordingly, the first detectable portion 60a and the second detectable portion 60b are alternately arranged along the X-axis. Consequently, each pair of the first signal generator 50a and the first detectable portion 60a corresponds to one of the plurality of the first keys 22a, and each pair of the second signal generator 50b and the second detectable portion 60b corresponds to one of the plurality of the second keys 22b.

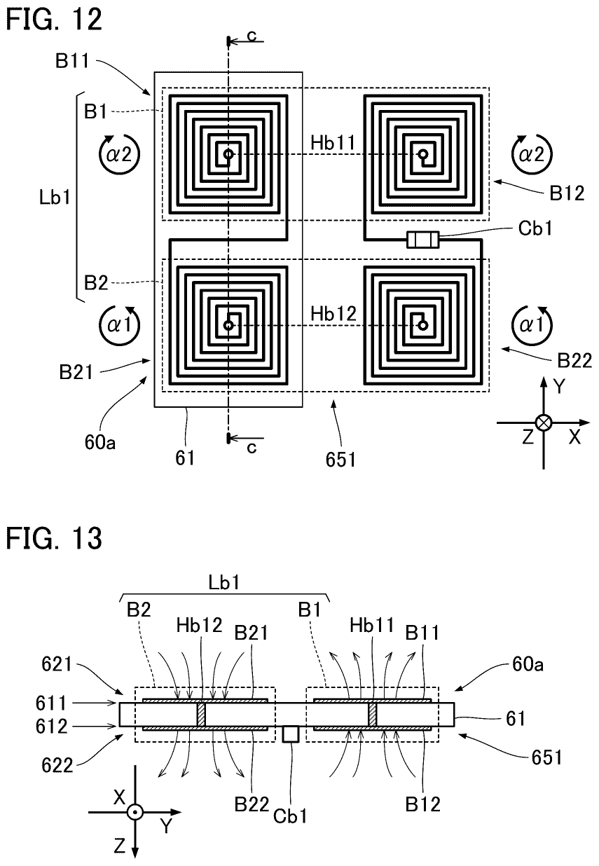

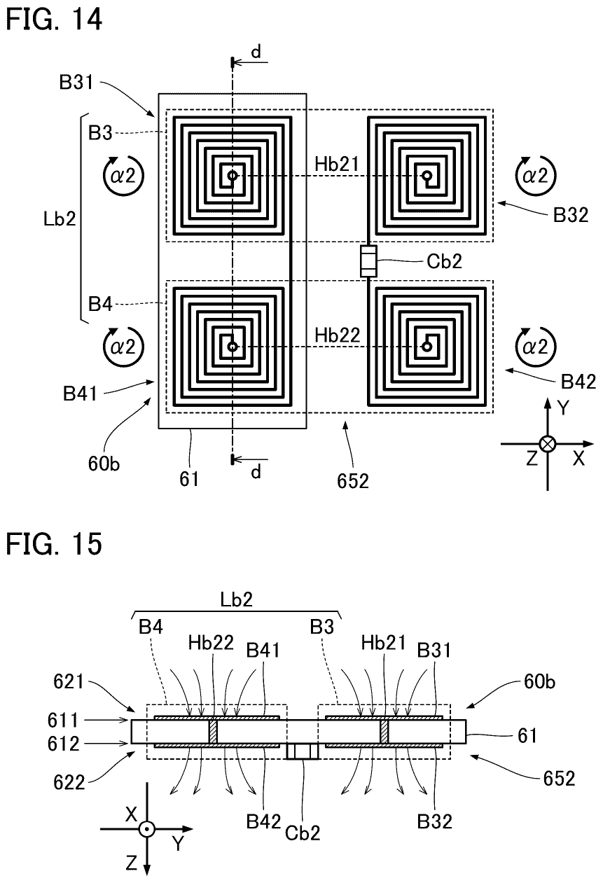

FIG. 12 is a plan view of the first detectable portion 60a viewed in the positive direction of the Z-axis, and FIG. 13 is a cross-sectional view taken along line c-c in FIG. 12. Further, FIG. 14 is a plan view of the second detectable portion 60b viewed in the positive direction of the Z-axis, and FIG. 15 is a cross-sectional view taken along line d-d in FIG. 14.

As illustrated in FIGS. 13 and 15, the detectable portions 60 (the first detectable portion 60a and the second detectable portion 60b) are disposed on the base member 61. The base member 61 is, for example, a rigid insulating board. Specifically, as illustrated in FIG. 7, the base member 61 is a plate-shaped member individually provided for each key 22. As illustrated in FIGS. 13 and 15, the base member 61 includes a first surface 611 and a second surface 612. The first surface 611 and the second surface 612 are surfaces in opposing relation to each other. The first surface 611 faces the bottom surface 221 of a key 22 of the base member 61, and the second surface 612 faces the signal generator 50. A capacitive element Cb (Cb1, Cb2) is mounted to the second surface 612. The base member 61 may otherwise be comprised of a flexible insulating film.

A conductive pattern 621 is formed on the first surface 611 of the base member 61. For example, the conductive pattern 621 is formed by patterning a conductive film over the entire area of the first surface 611. A conductive pattern 622 is formed on the second surface 612 of the base member 61. For example, the conductive pattern 622 is formed by patterning a conductive film over the entire area of the second surface 612. The configuration of each of the first detectable portion 60a and the second detectable portion 60b is described below.

### First Detectable Portion 60a

As illustrated in FIGS. 12 and 13, the first detectable portion 60a includes a first detectable coil Lb1 as the detectable coil Lb shown in FIG. 3. The first detectable coil Lb1 comprises a first portion B1 and a second portion B2. The first portion B1 and the second portion B2 are aligned in the Y-axis direction (that is, in the longitudinal direction of each of the plurality of the keys 22). Specifically, the first portion B1 is positioned in the positive direction of the Y-axis as viewed from the second portion B2.

The first portion B1 is comprised of a stack made up of a wound portion B11 and a wound portion B12. The second portion B2 is comprised of a stack made up of a wound portion B21 and a wound portion B22. The wound portion B11 and the wound portion B21 are included in the conductive pattern 621 of the first surface 611, and are each in a shape of a spiral that turns clockwise from the inner circumference to the outer circumference as viewed in the positive direction of the Z-axis. On the other hand, the wound portion B12 and the wound portion B22 are included in the conductive pattern 622 of the second surface 612, and are each in a shape of a spiral that turns counterclockwise from the inner circumference to the outer circumference as viewed in the positive direction of the Z-axis. The center of the wound portion B11 and the center of the wound portion B12 are electrically connected to each other via the conductive through-hole Hb11. Similarly, the center of the wound portion B21 and the center of the wound portion B22 are electrically connected to each other via a conductive through-hole Hb12. The conductive through-hole Hb (Hb11, Hb12, Hb21, Hb22) is a through hole formed in the base member 51. A capacitive element Cb1 is disposed between the wound portion B11 and the wound portion B21. The first detector Lb1 and the capacitive element Cb1 are connected to each other to form a first resonant circuit 651. The capacitive element Cb1 is an example of a “first capacitive element.”

As will be understood from FIG. 12, when a current flows in the second direction α2 in the wound portion B11, a current also flows in the second direction α2 in the wound portion B12. When a current flows in the second direction α2 in the wound portion B11, a current also flows in the first direction α1, which is opposite to the second direction α2, in both the wound portion B21 and the wound portion B22. That is, a current flows in the second direction α2 in the first portion B1 of the first detectable portion 60a, and a current flows in the first direction α1 in the second portion B2. Accordingly, an induced current is generated in the first detectable coil Lb1 by electromagnetic induction of a magnetic field generated by the first drive coil La1, and consequently, as illustrated in FIG. 13, magnetic fields in opposite directions are generated respectively in the first portion B1 and the second portion B2. However, the induced current generated in the first detectable coil Lb1 is very weak.

### Second Detectable Portion 60b

As illustrated in FIGS. 14 and 15, the second detectable portion 60b includes a second detectable coil Lb2 as the detectable coil Lb shown in FIG. 3. The second detectable coil Lb2 includes a third portion B3 and a fourth portion B4. The third portion B3 and the fourth portion B4 are aligned in the Y-axis direction (the longitudinal direction of each of the plurality of the keys 22). Specifically, the third portion B3 is positioned in the positive direction of the Y-axis as viewed from the fourth portion B4.

The third portion B3 is comprised of a stack made up of a wound portion B31 and a wound portion B32. The fourth portion B4 is comprised of a stack made up of a wound portion B41 and a wound portion B42. The wound portion B31 and the wound portion B41 are included in the conductive pattern 621 of the first surface 611; and the wound portion B32 and the wound portion B42 are included in the conductive pattern 622 of the second surface 612. The wound portion B31 and the wound portion B42 are each in a shape of a spiral that turns clockwise from the inner circumference to the outer circumference as viewed in the positive direction of the Z-axis. On the other hand, the wound portion B32 and the wound portion B41 are each in a shape of a spiral that turns counterclockwise from the inner circumference to the outer circumference as viewed in the positive direction of the Z-axis. The center of the wound portion B31 and the center of the wound portion B32 are electrically connected to each other via the conductive through-hole Hb21. Similarly, the center of the wound portion B41 and the center of the wound portion B42 are electrically connected to each other via the conductive through-hole Hb22. A capacitive element Cb2 is disposed between the wound portion B32 and the wound portion B42. The second detector Lb2 and the capacitive element Cb2 are connected to each other to form the second resonant circuit 652. The capacitive element Cb2 is an example of a “second capacitive element.”

As will be understood from FIG. 14, when a current flows in the second direction α2 in the wound portion B31, a current also flows in the second direction α2 in the wound portion B32. When a current flows in the second direction α2 in the wound portion B31, a current also flows in the second direction α2 in the wound portion B41 and the wound portion B42. That is, a current flows in the second direction α2 in both the third portion B3 and the fourth portion B4. Therefore, an induced current is generated in the second detectable coil Lb2 by the electromagnetic induction of the magnetic field generated by the second drive coil La2, and consequently, as illustrated in FIG. 15, magnetic fields in the same direction are generated respectively in the third portion B3 and the fourth portion B4. However, the induced current generated in the second detectable coil Lb2 is very weak.

As described above, the first detectable portion 60a includes the first portion B1 and the second portion B2 through which currents flow in opposite directions. The second detectable portion 60b includes a third portion B3 and a fourth portion B4 through which currents flow in the same direction.

As illustrated in FIG. 7, the first driver A1 of the first drive coil La1 and the third driver A3 of the second drive coil La2 are adjacent to each other in the X-axis direction. The second driver A2 of the first drive coil La1 and the fourth driver A4 of the second drive coil La2 are adjacent to each other in the X-axis direction. The first portion B1 of the first detectable coil Lb1 and the third portion B3 of the second detectable coil Lb2 are adjacent to each other in the X-axis direction. The second portion B2 of the first detectable coil Lb1 and the fourth portion B4 of the second detectable coil Lb2 are adjacent to each other in the X-axis direction.

Further, the first driver A1 of the first drive coil La1 and the first portion B1 of the first detectable coil Lb1 face each other in the Z-axis direction; and the second driver A2 of the first drive coil La1 and the second portion B2 of the first detectable coil Lb1 face each other in the Z-axis direction. Further, the third driver A3 of the second drive coil La2 and the third portion B3 of the second detectable coil Lb2 face each other in the Z-axis direction; and the fourth driver A4 of the second drive coil La2 and the fourth portion B4 of the second detectable coil Lb2 face each other in the Z-axis direction.

An induced current in the second direction α2 is generated in the first portion B1 of the first detectable coil Lb1 by the electromagnetic induction of the first driver A1. An induced current in the first direction α1 is generated in the second portion B2 of the first detectable coil Lb1 by the electromagnetic induction of the second driver A2. That is, a magnetic field that cancels out the change in the magnetic field of the first drive coil La1 is generated by the first detectable coil Lb1. The magnetic field generated by the first detectable coil Lb1 varies depending on a distance between the first drive coil La1 and the first detectable coil Lb1. Therefore, a detection signal D having an amplitude δ based on a distance between the first drive coil La1 and the first detectable coil Lb1 is output from the output terminal T2 of the first signal generator 50a. As will be understood from the foregoing explanation, the first signal generator 50a generates a detection signal D based on a distance between the first drive coil La1 and the first detectable coil Lb1. In the following explanation, the detection signal D generated by the first signal generator 50a may be referred to as a “first detection signal D1.”

An induced current in the second direction α2 is generated in the third portion B3 of the second detectable coil Lb2 by the electromagnetic induction of the third driver A3. An induced current in the second direction α2 is generated in the fourth portion B4 of the second detectable coil Lb2 by the electromagnetic induction of the fourth driver A4. That is, a magnetic field that cancels out the change in the magnetic field of the second drive coil La2 is generated by the second detectable coil Lb2. The magnetic field generated by the second detectable coil Lb2 varies depending on a distance between the second drive coil La2 and the second detectable coil Lb2. Therefore, a detection signal D having an amplitude δ based on a distance between the second drive coil La2 and the second detectable coil Lb2 is output from the output terminal T2 of the second signal generator 50b. As will be understood from the above explanation, the second signal generator 50b generates a detection signal D based on the distance between the second drive coil La2 and the second detectable coil Lb2. In the following explanation, the detection signal D generated by the second signal generator 50b may be referred to as a “second detection signal D2.”

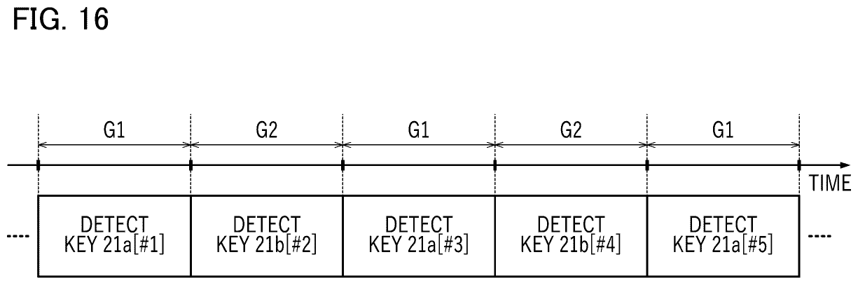

FIG. 16 is an explanatory diagram of the operation of the detection system 25. A period during which the detection system 25 operates is divided into a plurality of drive periods G (G1, G2) corresponding to different ones of the plurality of the keys 22. Each drive period G is set to be sufficiently short relative to a time required the user to press or release a corresponding one of the plurality of the keys 22. Each drive period G is a period for detecting the position P of one of the plurality of the keys 22. That is, the position P of each of the plurality of the keys 22 is sequentially detected in time division for a corresponding drive period G. The detection operation of the position P is repeated for each one of the plurality of the keys 22 across the entire keyboard 21. Specifically, the drive circuit 70 performs an operation of: selecting, in one each of the plurality of drive periods G, one of the plurality of the keys 22 corresponding to the drive period, to supply a drive signal W to the signal generator 50 that corresponds to the selected one of the plurality of the keys 22, and acquiring a detection signal D generated by the signal generator 50.

The plurality of the drive periods G includes first drive periods G1 and second drive periods G2. A first drive period G1 is a period for detecting a position P of a first key 22a. A second drive period G2 is a period for detecting a position P of a second key 22b. The first drive periods G1 and the second drive periods G2 are alternately arranged on a time axis.

The drive circuit 70 supplies a drive signal W to the first signal generator 50a and acquires a first detection signal D1 generated by the first signal generator 50a in one each of the first drive periods G1. The drive circuit 70 supplies a drive signal W to the second signal generator 50b and acquires a second detection signal D2 generated by the second signal generator 50b in one each of the second drive periods G2. That is, the first signal generator 50a and the second signal generator 50b are time-division driven. The drive signal W supplied to the first signal generator 50a in the first drive period G1 is an example of a “first drive signal,” and the drive signal W supplied to the second signal generator 50b in the second drive period G2 is an example of a “second drive signal.”

As described above, an induced current is generated in the first detectable coil Lb1 by a magnetic field generated by the first drive coil La1, and a first detection signal D1 is generated as a result based on a distance between the first drive coil La1 and the first detectable coil Lb1. Similarly, an induced current is generated in the second detectable coil La2 by a magnetic field generated by the second drive coil Lb2, and a second detection signal D2 is generated as a result based on a distance between the second drive coil La2 and the second detectable coil Lb2. In this way, the position P each of the plurality of the keys 22 (the first keys 22a and the second keys 22b) can be detected.

As a comparative example, a configuration is assumed in which only a pair of the first signal generator 50a and the first detectable portion 60a is arranged corresponding to one each of the plurality of the keys 22. In this comparative example, a problem is assumed in which a magnetic field interferes between two of the plurality of the keys 22 that are adjacent to each other in the X-axis direction (hereinafter, “two adjacent keys”). The interference causes a reduction in the detection accuracy of the position P of the one of the plurality of the keys 22. To overcome this problem, configurations are required that reduce interference of the magnetic field between the two adjacent keys. For example, a configuration in which the resonance frequency of the signal generator 50 and the detectable portion 60 of one of the two adjacent keys differ from that of the other of the two adjacent keys, or a configuration in which the positions of the signal generator 50 and the detectable portion 60 in the Y-axis direction of one of the two adjacent keys differ from those of the other of the two adjacent keys may be used.

In contrast to the Comparative Example, in the first embodiment, currents flow through the first driver A1 and the second driver A2 of the first drive coil La1 in opposite directions, while currents flow through the third driver A3 and the fourth driver A4 of the second drive coil La2 in the same direction. In addition, currents flow in the first portion B1 and the second portion B2 of the first detectable coil Lb1 in opposite directions, while currents flow in the third portion B3 and the fourth portion B4 of the second detectable coil Lb2 in the same direction. According to the above configuration, the interference of magnetic fields between two adjacent keys is reduced, and consequently, the position P of each of the plurality of the keys 22 can be detected with high accuracy. The effects of the first embodiment are described in detail below.

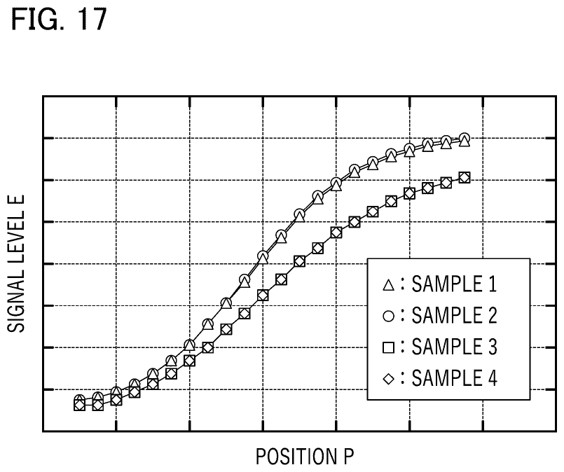

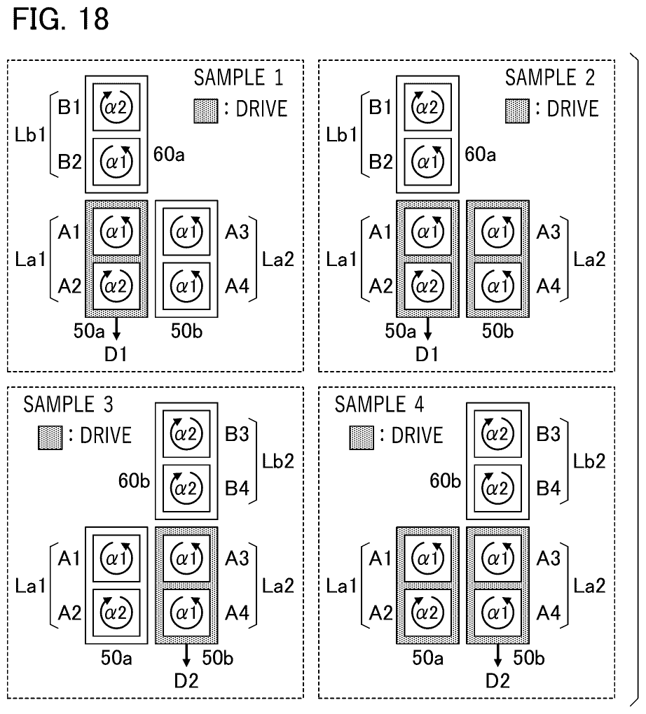

FIG. 17 is a graph showing measurements of a relationship between the position P of each of the plurality of the keys 22 and the signal level E of a detection signal D for one of the plurality of the keys 22. In FIG. 17, a signal level E is measured using a configuration in which the first signal generator 50a, the second signal generator 50b, and the detectable portion 60 (the first detectable portion 60a or the second detectable portion 60b) are disposed. The horizontal axis of FIG. 17 corresponds to the distance between the drive coil La and the detectable coil Lb. That is, the numerical value of the position P is decreased by pressing of a key. FIG. 18 is an explanatory diagram of Samples 1 to 4 in FIG. 17.

In Sample 1 and Sample 2, the first detectable portion 60a was moved in the Z-axis direction, with the first detectable portion 60a facing the first signal generator 50a. The second detectable portion 60b was not disposed. In Sample 1, the signal level E was measured of a first detection signal D1 generated by the first signal generator 50a when the drive signal W was supplied only to the first signal generator 50a. On the other hand, in Sample 2, the signal level E of a first detection signal D1 generated by the first signal generator 50a was measured when the drive signal W was supplied in parallel to both the first signal generator 50a and the second signal generator 50b. In this specification, “in parallel” or “concurrently” refers to processes that happen over overlapping periods but do not necessarily start and end at the same exact moment.

In Sample 3 and Sample 4, the second detectable portion 60b was moved in the Z-axis direction, with the second detectable portion 60b facing the second signal generator 50b. The first detectable portion 60a was not disposed. In Sample 3, the signal level E was measured for a second detection signal D2 generated by the second signal generator 50b when the drive signal W was supplied only to the second signal generator 50b. On the other hand, in Sample 4, the signal level E was measured for a second detection signal D2 generated by the second signal generator 50b when the drive signal W was supplied in parallel to both the first signal generator 50a and the second signal generator 50b.

As shown in FIG. 17, the relationship between the position P and the signal level E is substantially the same in both Sample 1 and Sample 2. Thus, as will be understood from comparison of Sample 1 and Sample 2, regardless of whether the second signal generator 50b is driven, the generation of the first detection signal D1 by the first signal generator 50a is not affected.

A case is assumed in which a magnetic field is generated in the second drive coil La2 by driving the second signal generator 50b. Magnetic fields in the same direction are generated in both the third driver A3 and the fourth driver A4 of the second drive coil La2. The magnetic field of the second drive coil La2 reaches the first detectable coil Lb1 of the first detectable portion 60a of the adjacent key 22. In this situation, electromagnetic induction generated by the magnetic field of the second drive coil La2 typically generates induced currents in the same direction in both the first portion B1 and the second portion B2 of the first detectable coil Lb1. However, because the first portion B1 and the second portion B2 are connected to each other in such a way that currents flow therethrough in opposite directions, the induced currents are cancelled between the first portion B1 and the second portion B2. For the above reasons, the effect of the magnetic field of the second drive coil La2 on the first detectable coil Lb1 is reduced.

The magnetic field of the second drive coil La2 also reaches the first drive coil La1 of the first signal generator 50a adjacent to the second drive coil La2. Therefore, the electromagnetic induction generated by the magnetic field of the second drive coil La2 typically generates induced currents in the same direction for both the first driver A1 and the second driver A2 of the first drive coil La1. However, because the first driver A1 and the second driver A2 are connected to each other in such a way that currents flow therethrough in opposite directions, the induced currents are cancelled between the first driver A1 and the second driver A2. Thus, the effect of the magnetic field of the second drive coil La2 on the first drive coil La1 is reduced.

For the reasons described above, a magnetic field generated by the second drive coil La2 by driving the second signal generator 50b does not affect the generation of a first detection signal D1 using the first drive coil La1 and the first detectable coil Lb1, as described above.

Furthermore, the relationship between the position P and the signal level E is substantially the same for both Sample 3 and Sample 4. Thus, as will be understood from the comparison of Sample 3 and Sample 4, regardless of whether the first signal generator 50a is driven, the generation of the second detection signal D2 by the second signal generator 50b is not affected.

It is assumed that a magnetic field is generated in the first drive coil La1 by driving the first signal generator 50a. Magnetic fields in opposite directions are generated in the first driver A1 and the second driver A2 of the first drive coil La1. The magnetic field of the first drive coil La1 reaches the second detectable coil Lb2 of the second detectable portion 60b of an adjacent key 22. Consequently, the electromagnetic induction caused by the magnetic field of the first drive coil La1 typically generates induced currents in opposite directions in the third portion B3 and the fourth portion B4 of the second detectable coil Lb2. However, because the third portion B3 and the fourth portion B4 are connected to each other such that currents flow therethrough in the same direction, the induced currents are cancelled between the third portion B3 and the fourth portion B4. For the above reasons, the effect of the magnetic field of the first drive coil La1 on the second detectable coil Lb2 is reduced.

The magnetic field of the first drive coil La1 also reaches the second drive coil La2 of the second signal generator 50b of the adjacent key 22. The electromagnetic induction caused by the magnetic field of the first drive coil La1 typically generates induced currents in opposite directions in the third driver A3 and the fourth driver A4 of the second drive coil La2. However, because the third driver A3 and the fourth driver A4 are connected such that currents flow therethrough in the same direction, the induced current is cancelled between the third driver A3 and the fourth driver A4. Thus, the effect of the first signal generator 50a on the second drive coil La2 is reduced.

For the reasons described above, a magnetic field generated by the first drive coil La1 by the driving of the first signal generator 50a does not affect the generation of a second detection signal D2 using the second drive coil La2 and the second detectable coil Lb2.

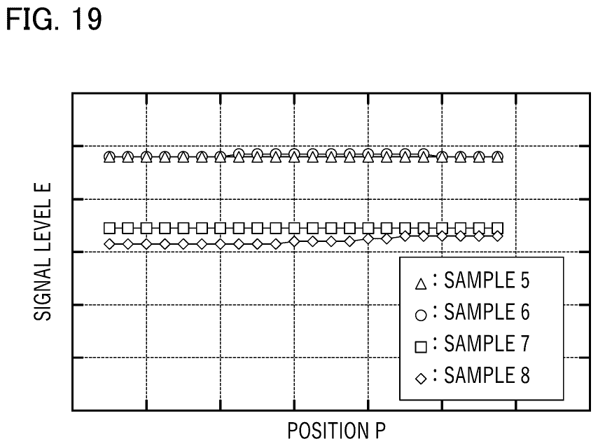

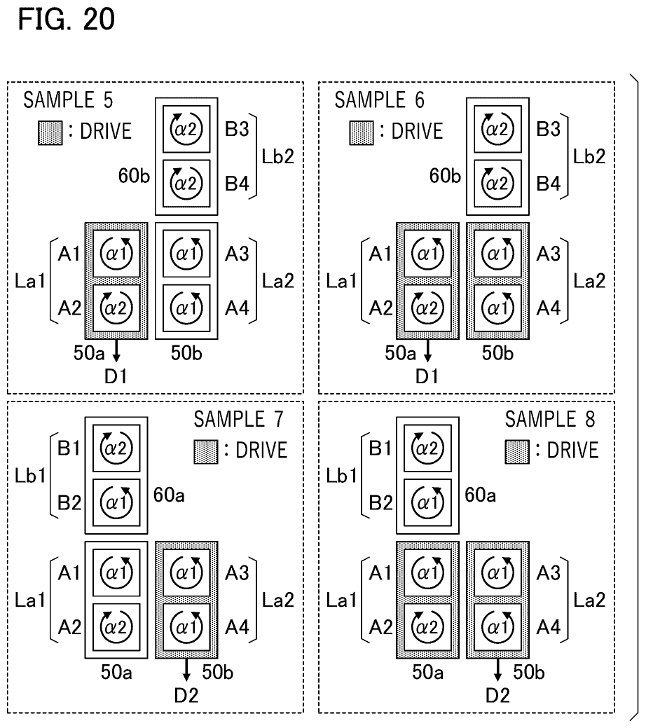

FIG. 19 is a graph showing measurements of a relationship between the position P each of the plurality of the keys 22 and the signal level E of a detection signal D for the key 22, similarly to FIG. 17. FIG. 20 is an explanatory diagram of Samples 5 to 8 in FIG. 19.

In Sample 5 and Sample 6, the second detectable portion 60b was moved in the Z-axis direction, with the second detectable portion 60b facing the second signal generator 50b. The first detectable portion 60a was not disposed. In Sample 5, the signal level E was measured for a first detection signal D1 generated by the first signal generator 50a when the drive signal W was supplied only to the first signal generator 50a. On the other hand, in Sample 6, the signal level E was measured for a first detection signal D1 generated by the first signal generator 50a when the drive signal W was supplied in parallel to both the first signal generator 50a and the second signal generator 50b.

In Sample 7 and Sample 8, the first detectable portion 60a was moved in the Z-axis direction, with the first detectable portion 60a facing the first signal generator 50a. The second detectable portion 60b was not disposed. In Sample 7, the signal level E was measured for a second detection signal D2 generated by the second signal generator 50b when the drive signal W was supplied only to the second signal generator 50b. On the other hand, in Sample 8, the signal level E was measured for a second detection signal D2 generated by the second signal generator 50b when the drive signal W was supplied in parallel to both the first signal generator 50a and the second signal generator 50b.

As will be understood from comparison of Sample 5 and Sample 6, in addition to whether the second signal generator 50b has been driven, the position P of the second detectable portion 60b does not affect the generation of a first detection signal D1 by the first signal generator 50a. Further, as will be understood from comparison of Sample 7 and Sample 8, in addition to whether the first signal generator 50a has been driven, the position P of the first detectable portion 60a does not affect the generation of a second detection signal D2 by the second signal generator 50b.

As described above, according to the first embodiment, the influence of magnetic fields is reduced between a pair of the first drive coil La1 and the first detectable coil Lb1 (hereafter, a “first coil pair”) and a pair of the second drive coil La2 and the second detectable coil Lb2 (hereafter, a “second coil pair”). Therefore, even in a configuration in which the first key 22a and the second key 22b are adjacent to each other, it is possible to generate a detection signal D that reflects the position P each of the first key 22a and the second key 22b with high accuracy.

As described above, according to the first embodiment, since the influence of magnetic fields between the first coil pair and the second coil pair is reduced, the resonance frequency for the signal generator 50 and the detectable portion 60 of one of two adjacent keys need not differ from that of the other of the two adjacent keys in the first embodiment; and the signal generator 50 and the detectable portion 60 in the direction of the Y-axis for one of two adjacent keys need not be positioned differently from those for the other of the two adjacent keys in the first embodiment, etc., although these configurations can still be adopted in the first embodiment if desired. In addition, since the effect of the magnetic fields between the first coil pair and the second coil pair is reduced, it is possible to enhance a magnetic field generated by the first drive coil La1 and the second drive coil La2 as compared with the Comparison Example. Consequently, a wide range of positions P can be detected for each of the first keys 22a and the second keys 22b.

### B: Second Embodiment

A second embodiment will now be described. It is of note that, in each of the aspects explained below, elements whose functions are the same as those of the first embodiment will be described using the same reference numerals as those of the first embodiment, and detailed descriptions thereof will be omitted as appropriate.

As described with reference to FIG. 16, in the first embodiment, each of the plurality of signal generators 50 is sequentially driven for each drive period G. However, as also described above, since the influence of magnetic fields on each other between the first coil pair and the second coil pair is reduced, even if the first coil pair and the second coil pair operate in parallel to each other, it is possible to measure the position P each of the plurality of the keys 22 with high accuracy. In view of the above-described circumstances, in the second embodiment, a drive signal W is supplied to the second signal generator 50b in parallel with a drive signal W supplied to the first signal generator 50a.

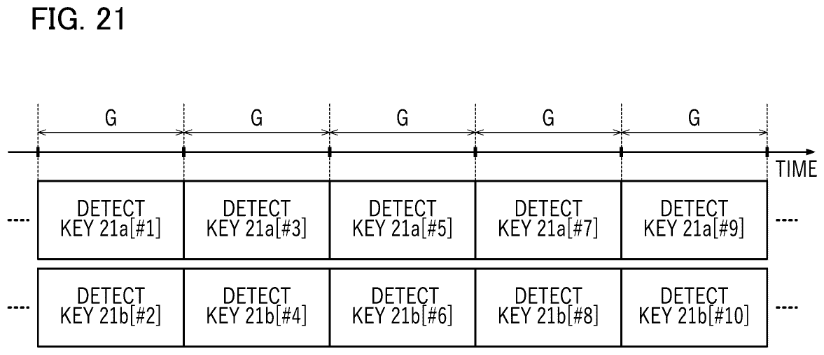

FIG. 21 is an explanatory diagram of an operation of a detection system 25 according to the second embodiment. The drive circuit 70 of the second embodiment drives in parallel the first signal generator 50a and the second signal generator 50b corresponding to two adjacent keys 22 (the first key 22a and the second key 22b). In other words, the drive circuit 70 supplies in parallel a drive signal W to the first signal generator 50a and a drive signal W to the second signal generator 50b during one each of the drive periods G. In addition, the drive circuit 70 receives in parallel a first detection signal D1 generated by the first signal generator 50a and a second detection signal D2 generated by the second signal generator 50b in one each of the drive periods G.

A position P each of the plurality of the keys 22 is specified based on a signal level E of a detection signal D generated by each signal generator 50 in the same manner as that of the first embodiment. By repeating the above processes for different pairs of the first signal generator 50a and the second signal generator 50b, the position P each of the plurality of the keys 22 is specified. The drive signal W supplied to the first signal generator 50a in the respective drive period G is an example of a “first drive signal,” and the drive signal W supplied to the second signal generator 50b in the drive period G is an example of a “second drive signal.”

In the second embodiment, the same effects as those of the first embodiment can be attained. In the second embodiment, the first signal generator 50a and the second signal generator 50b are driven in parallel to each other. Therefore, compared with the first embodiment in which the first signal generator 50a and the second signal generator 50b are driven in different drive periods G (G1, G2), in the second embodiment, it is easy to ensure a duration of a drive period G.

On the other hand, in the first embodiment, the first signal generator 50a is driven in a drive period G1, and the second signal generator 50b is driven in a drive period G2 that is different from the drive period G1. Therefore, compared with the second embodiment in which the first signal generator 50a and the second signal generator 50b are driven in parallel, it is possible to further reliably reduce the effect of the magnetic fields between the first coil pair and the second coil pair according to the first embodiment.

### C: Third Embodiment

In the first embodiment, the position P of one each of the plurality of the keys 22 is specified based on a signal level E of a detection signal D by using the correlation table F. However, as will be understood from FIG. 17, the relationship between the position P of the first key 22a and the signal level E of a first detection signal D1 (Sample 1 and Sample 2) may be different from the relationship between the position P of the second key 22b and the signal level E of a second detection signal D2 (Sample 3 and Sample 4). In view of these circumstances, in the third embodiment, (i) a relationship between (a) a signal level E of a first detection signal D1 and (b) a position P of the first key 22a specified by the control device 31 (position analyzer) based on the signal level E, differs from (ii) a relationship between (c) a signal level E of a second detection signal D2 and (d) a position P of the second key 22b specified by the control device 31 (position analyzer) from the signal level E.

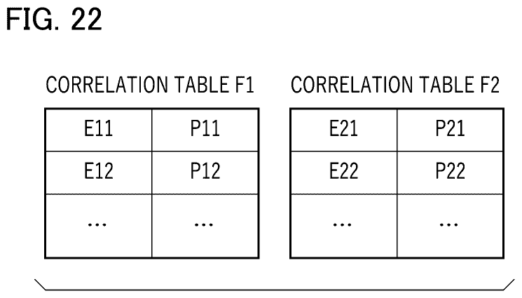

FIG. 22 is a schematic diagram of correlation tables F (F1, F2) used by the control device 31 to specify the position P of each of the plurality of the keys 22 (S2). A storage device 32 of the third embodiment stores the correlation table F1 and the correlation table F2.

The correlation table F1 is used to specify the position P of each of the first keys 22a based on a first detection signal D1 generated by the first signal generator 50a. Specifically, the correlation table F1 is a data table in which a position P (P11, P12, . . . ) each of the first keys 22a is set for one each of a plurality of possible numerical values (E11, E12, . . . ) for the signal level E of the first detection signal D1.

The correlation table F2 is used to identify the position P each of the second keys 22b based on a second detection signal D2 generated by the second signal generator 50b. Specifically, the correlation table F2 is a data table in which a position P (P21, P22, . . . ) each of the second keys 22b is set for one each of a plurality of possible numerical values (E21, E22, . . . ) for the signal level E of the second detection signal D2.

A position P that corresponds to one numerical value of the signal level E in the correlation table F1 differs from the corresponding position in the correlation table F2. For example, as will be understood from FIG. 17, a signal level E of a first detection signal D1 when the first key 22a is at a specific position P is higher than a signal level E of a second detection signal D2 when the second key 22b is at the specific position P. In view of the above differences, the numerical value of a position P corresponding to a specific signal level E in the correlation table F1 is higher than the numerical value of a position P corresponding to the specific signal level E in the correlation table F2.

The control device 31 (position analyzer) uses the correlation table F1 to specify the position P of the first key 22a from the signal level E of a first detection signal D1, and uses the correlation table F2 to specify the position P of the second key 22b from the signal level E of a second detection signal D2. Configurations and operations other than specifying the position P are the same as those of the first embodiment.

In the third embodiment, the same effects as those of the first embodiment can be obtained. In the third embodiment, the relationship between the signal level E of a first detection signal D1 and the position P of the first key 22a differs from the relationship between the signal level E of a second detection signal D2 and the second key 22b. Therefore, in a mode in which the signal level E of a first detection signal D1 and the signal level E of a second detection signal D2 are different when the first key 22a and the second key 22b are at the same position P, it is possible to specify with high accuracy the position P each of the first key 22a and the second key 22b.

### D: Fourth Embodiment

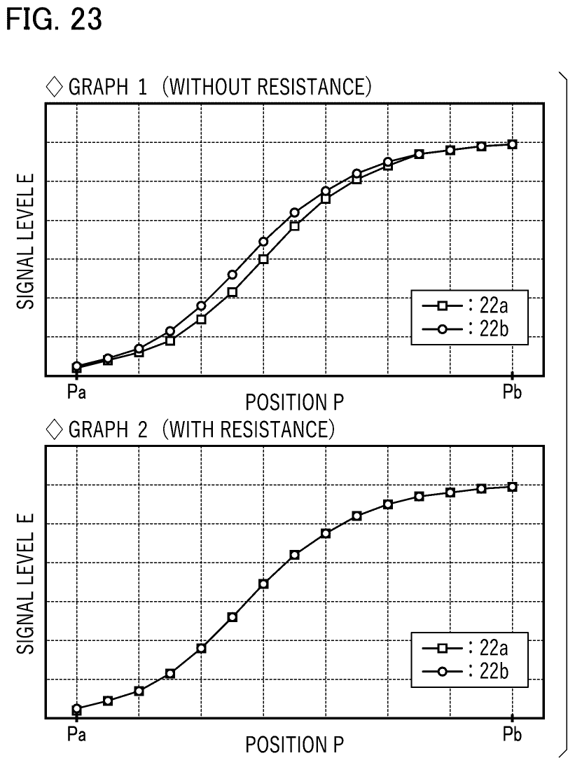

FIG. 23 is a graph showing a relationship between the position P each of the plurality of the keys 22 and the signal level E of a detection signal D (hereafter, “position-level characteristics”) for a key 22. In FIG. 23, the position-level characteristics of the first key 22a and the position-level characteristics of the second key 22b are both shown.

A position Pa in FIG. 23 is the position P of one each of the plurality of the keys 22, with the drive coil La and the detectable coil Lb being closest to each other. That is, the position Pa is the position P of one each of the plurality of the keys 22 that is depressed to the lower end of a displaceable range. A position Pb in FIG. 23 is the position P of one each of the plurality of the keys 22 in which the drive coil La and the detectable coil Lb are furthest apart from each other. That is, the position Pb is the position P of one each of the plurality of the keys 22 in the released state. As will be understood from the above explanation, the horizontal axis of FIG. 23 is representative of a distance between the drive coil La and the detectable coil Lb.

As illustrated in the form of Graph 1 in FIG. 23, by adjusting conditions of the drive coil La and the detectable coil Lb, the signal level E at the position Pa of one each of the first keys 22a can be matched with the signal level E of the position Pb of the corresponding second key 22b. The conditions of the drive coil La and the detectable coil Lb include, for example, the number of coil turns, a wire width, an external size, a radial spacing, or other relevant parameters.

With a configuration in which the conditions of the first drive coil La1 differ from the conditions of the second drive coil La2, or with a configuration in which the conditions of the first detectable coil Lb1 differ from the conditions of the second detectable coil Lb2, the signal levels E at the position Pa and the position Pb of each of the first keys 22a can be matched with the corresponding signal levels of each of the second keys 22b. Specifically, the conditions of the drive coil La and the detectable coil Lb are determined such that an inductance of the first drive coil La1 and an inductance of the second drive coil La2 are substantially coincident, and an inductance of the first detectable coil Lb1 and an inductance of the second detectable coil Lb2 are substantially coincident.

However, as will be apparent from Graph 1 of FIG. 23, simply adjusting respective conditions of the drive coil La and the detectable coil Lb, the position-level characteristics of one each of the first keys 22a may partially differ from the corresponding characteristics of one each of the second keys 22b within a range between the position Pa and the position Pb. A fourth embodiment is a mode for reducing the differences in position-level characteristics described above.

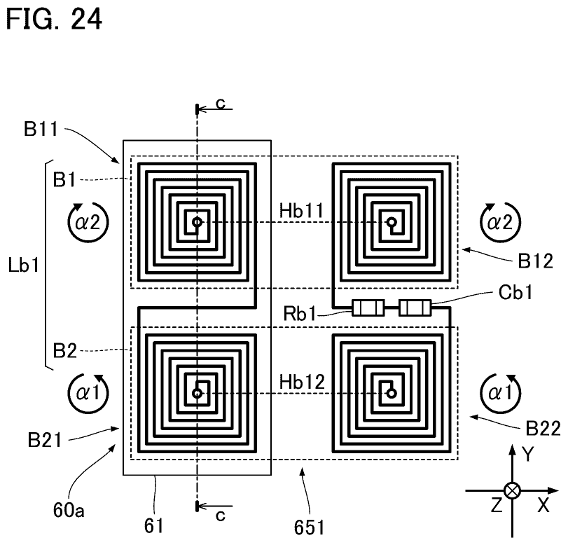

FIG. 24 is a plan view of a first detectable portion 60a in the fourth embodiment. A first resonant circuit 651 of the first detectable portion 60a in the fourth embodiment includes a resistive element Rb1, in addition to a first detectable coil Lb1 and a capacitive element Cb1 that are substantially the same as those in the first embodiment. The resistive element Rb1 is an example of a “first resistive element.”

The resistive element Rb1 is a chip resistor connected to the first detectable coil Lb1. The resistive element Rb1 is connected in series to the first detectable coil Lb1 and the capacitive element Cb1. The resistive element Rb1 is disposed on the second surface 612 (see FIG. 13) of the base member 61 together with the capacitive element Cb1.

In the above configuration, the position-level characteristics of one each of the first keys 22a vary depending on a resistance of the resistive element Rb1. Specifically, the position-level characteristics within the range between the position Pa and the position Pb change based on the resistance of the resistive element Rb1. As illustrated as Graph 2 in FIG. 23, a resistance value of the resistive element Rb1 is determined such that the position-level characteristics within the range between the position Pa and the position Pb of one each of the first keys 22a and the corresponding characteristics of one each of the second keys 22b are close to each other (ideally match). Specifically, the resistance value of the resistive element Rb1 is lower than the resistance value of resistance components (DC resistance) associated with the first detectable coil Lb1.

In the fourth embodiment, the same effects as those of the first embodiment can be attained. Furthermore, in the fourth embodiment, since the resistive element Rb1 is connected to the first detectable coil Lb1 of the first detectable portion 60a, as described above, the position-level characteristics of one each of the first keys 22a throughout the entire range between the position Pa and the position Pb can be kept substantially the same as (ideally matched with) the corresponding characteristics of one each of the second keys 22b. Although the fourth embodiment is based on the first embodiment, the configuration of the second embodiment or that of the third embodiment may be similarly employed in the fourth embodiment.

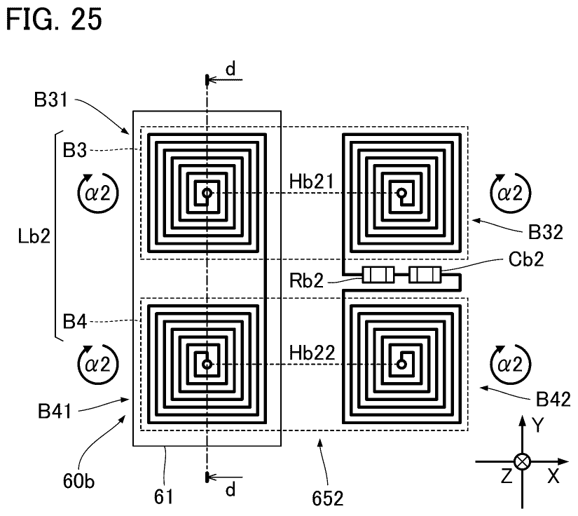

In the above description, the resistive element Rb1 is added to the first detectable portion 60a, but instead a resistive element Rb2 may be added to the second detectable portion 60b, as illustrated in FIG. 25. The resistive element Rb2 is connected in series to the second detectable coil Lb2 and the capacitive element Cb2 to form the second resonant circuit 652. The resistive element Rb2 is an example of a “second resistive element.”

The resistive element Rb2 is a chip resistor connected to the second detectable coil Lb2, and is disposed on the second surface 612 (see FIG. 15) of the base member 61 together with the capacitive element Cb2. The position-level characteristics of the second key 22b change in accordance with the resistance of the resistive element Rb2. Thus, the resistance value of the resistive element Rb2 is determined such that the position-level characteristics of one each of the first keys 22a in the range between the position Pa and the position Pb are close to (ideally match) the corresponding characteristics for one each of the second keys 22b. For example, the resistance value of the resistive element Rb2 is lower than the resistance value of resistance components (DC resistance) associated with the second detectable coil Lb2. Also in the embodiment of FIG. 25, effects similar to those of the fourth embodiment can be realized.

It is of note that both the resistive element Rb1 and the resistive element Rb2 may be provided. In a configuration including both the resistive element Rb1 and the resistive element Rb2, the resistance value of the resistive element Rb1 and the resistance value of the resistive element Rb2 may differ from each other. Furthermore, in the above description, the resistive element Rb1 and the resistive element Rb2 are chip resistors. However, the form of the resistive element Rb1 and the resistive element Rb2 is not limited thereto. For example, the resistive element Rb1 or the resistive element Rb2 may be realized by meandering the conductive pattern 621 or the conductive pattern 622.

### E: Modifications

Examples of modifications that can be appended to the embodiments described above will now be described. A plurality of forms freely selected from the above-described embodiments and the modifications exemplified below may be appropriately combined so long as such a combination does not give rise to any contradiction.
(1) In each of the above-described embodiments, the position P of each of the plurality of the keys 22 of the keyboard musical instrument 100 is detected. However, a movable member for which the position P is detected by the detection system 25 is not limited to the keys 22. Example forms of the movable member are described below.

### Form A

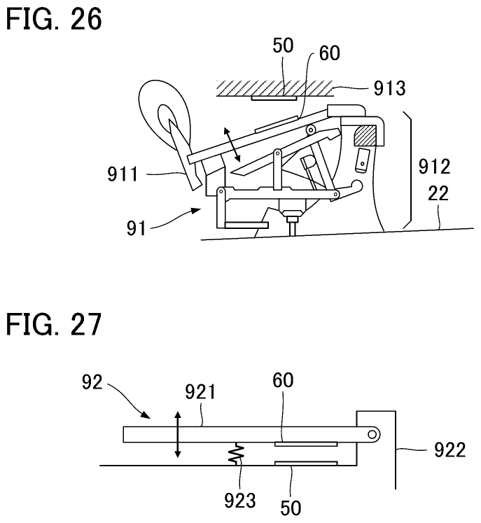

FIG. 26 is a schematic diagram of a configuration in which the detection system 25 is applied to a striking mechanism 91 of the keyboard musical instrument 100. Like the acoustic piano, the striking mechanism 91 is a mechanism that causes a string (not shown) to be struck in conjunction with the movement each of the plurality of keys 22 of the keyboard 21. Specifically, the striking mechanism 91 includes, for each of the plurality of the keys 22, a hammer 911 that can strike a string upon being caused to rotate, and a transmission mechanism 912 (for example, a wippen, a jack, a repetition lever, etc.,) that rotates the hammer 911 in conjunction with the movement of the key 22. In the above configuration, the detection system 25 detects the position of the hammer 911. Specifically, the detectable portion 60 is disposed on the hammer 911 (for example, on a hammer shank). On the other hand, the signal generator 50 is disposed on a support member 913. The support member 913 is, for example, a structure that supports the striking mechanism 91. The detectable portion 60 may be disposed on a member other than the hammer 911 in the striking mechanism 91.

### Form B

FIG. 27 is a schematic diagram of a configuration in which the detection system 25 is applied to a pedal mechanism 92 of the keyboard musical instrument 100. The pedal mechanism 92 includes a pedal 921 that is operated by a user's foot, a support member 922 that supports the pedal 921, and an elastic body 923 that biases the pedal 921 upward in the vertical direction. In the above configuration, the detection system 25 detects the position of the pedal 921. Specifically, the detectable portion 60 is disposed on the bottom surface of the pedal 921. The signal generator 50 is disposed on the support member 922 so as to face the detectable portion 60. It is of note here that the musical instrument for which the pedal mechanism 92 is used is not limited to the keyboard musical instrument 100. For example, a pedal mechanism 92 having a similar configuration can be used for a freely selected musical instrument, such as a percussion instrument.

Although the pedal mechanism 92 of the keyboard musical instrument 100 is illustrated in FIG. 27, the same configuration as that of FIG. 27 is adopted for a pedal mechanism used for an electric musical instrument, such as an electric stringed musical instrument (for example, an electric guitar). A pedal mechanism used in an electric musical instrument is an effect pedal operated by a user to adjust various sound effects such as distortion or a compression.

In addition, although the positions of the keys 22 of the keyboard musical instrument 100 are detected in each of the above-described embodiments, a target to be detected by the detection system 25 is not limited to the above-described example. For example, controls operated by a user when playing a wind instrument, such as a woodwind instrument (for example, a clarinet or a saxophone) or a brass instrument (for example, a trumpet or a trombone) may be detected by the detection system 25.

As will be understood from the above examples, a target to be detected by the detection system 25 is comprehensively represented as a movable member that moves in response to a playing operation. The movable member includes a playing operator (playing control), such as a key 22 or a pedal 921, which is directly operated by a user, and a structure, such as a hammer 911, that moves in conjunction with an operation made to the playing operator. However, the movable member in the present disclosure is not limited to a member that moves in accordance with a playing operation. That is, the movable member is referred to comprehensively as a movable member regardless of a trigger that generates the movement.
(2) In each of the above-described embodiments, the drive coil La (La1, La2) is comprised of two layers. However, the drive coil La may be comprised of a single layer or three or more layers. The detectable coil Lb (Lb1, Lb2) may likewise be comprised of a single layer or three or more layers.
(3) In each of the above-described embodiments, the drive signal W having the same waveform is supplied to the first signal generator 50a and the second signal generator 50b. However, the waveform, the period, the amplitude, and the like for the drive signal W (first drive signal) supplied to the first signal generator 50a may differ from those for the drive signal W (second drive signal) supplied to the second signal generator 50b.
(4) In each of the above-described embodiments, a configuration or electrical characteristics of the first signal generator 50a is the same as that of the second signal generator 50b. However, the configuration or the electrical characteristics of the first signal generator 50a may differ from that of the second signal generator 50b. For example, electric characteristics, such as the resistive value of the resistive element R, of the first signal generator 50a may differ from those of the second signal generator 50b. As a result, it is possible to make (i) the relationship between the position P of one each of the first keys 22a and the corresponding signal level E of the first detection signal D1 and (ii) the relationship between the position P of one each of the second keys 22b and the corresponding signal level E of the second detection signal D2 close to each other. Similarly, the configuration or electric characteristics of the first detectable portion 60a and the second detectable portion 60b may differ from each other.
(5) In each of the above-described embodiments, the signal level E of the detection signal D decreases when a key is depressed. However, the relationship between the change in the position P of each of the plurality of the keys 22 and the increase or decrease in the signal level E of the detection signal D is not limited thereto. For example, in a configuration in which the detectable portion 60 is disposed between the front end portion of the key 22 and the balance pin 23, the distance between the drive coil La and the detectable coil Lb is reduced by the when the key is depressed by the user. Therefore, the signal level E of the detection signal D increases when the key is depressed.
(6) In each of the above-described embodiments, the keyboard musical instrument 100 includes the sound source circuit 34. However, the sound source circuit 34 may be omitted in a configuration in which the keyboard musical instrument 100 includes, for example, a sound generating mechanism, such as the striking mechanism 91. The detection system 25 is used to record sound produced by playing the keyboard musical instrument 100. As will be understood from the above description, a musical instrument according to the present disclosure includes not only an electronic musical instrument including the sound source circuit 34 but also an acoustic musical instrument that includes a sound generating mechanism.

Furthermore, the present disclosure is also specified as a device (control device) that controls a music sound by outputting, to the sound source circuit 34 or the sound generation mechanism, a playing control signal corresponding to a playing operation. In addition to the musical instrument (keyboard musical instrument 100) including the sound source circuit 34 or the sound generating mechanism provided as examples in each of the above-described embodiments, a device (for example, a MIDI controller or the above-described pedal mechanism 92) without a sound source circuit 34 or the sound generating mechanism is included in the concept of the control device. In other words, an instrument playing apparatus of the present disclosure is referred to comprehensively as a device operated by a player (operator) for playing.
(7) As described above, the functions of the control system 30 according to each of the above-described embodiments are realized by cooperation of one or more processors constituting the control device 31 and a program stored in the storage device 32. The program illustrated above may be provided in a form stored in a computer-readable recording medium and installed in the computer. The recording medium is, for example, a non-transitory recording medium. An optical recording medium (optical disk), such as a CD-ROM, is one example, but any known type of recording medium, such as a semiconductor recording medium or a magnetic recording medium, is included. A non-transitory recording medium includes any recording medium except for a transitory, propagating signal, and a volatile recording medium is not excluded. Furthermore, in a configuration in which a distribution apparatus distributes the program via a communication network, a storage recording medium having stored the program in the distribution apparatus corresponds to the non-transitory recording medium described above.

### F: Appendix

As examples, the following aspects are derivable from the embodiments described above.

A detection system according to one aspect (Aspect 1) of the present disclosure includes a first detectable coil disposed on a first movable member; a second detectable coil disposed on a second movable member; a first signal generator, including a first drive coil that faces the first detectable coil, configured to generate a first detection signal based on a distance between the first detectable coil and the first drive coil; and a second signal generator, including a second drive coil that faces the second detectable coil, configured to generate a second detection signal based on a distance between the second detectable coil and the second drive coil. The first drive coil includes: a first driver through which current flows in a first direction; and a second driver through which current flows in a second direction opposite to the first direction, the second drive coil includes: a third driver through which current flows in the first direction; and a fourth driver through which current flows in the first direction, the first detectable coil includes a first portion and a second portion where induced currents in directions opposite to each other are generated by electromagnetic induction of the first drive coil, and the second detectable coil includes a third portion and a fourth portion where induced currents in a same direction as each other are generated by electromagnetic induction of the second drive coil.

In the above-described aspect, an induction current is generated in the first detectable coil by a magnetic field generated by the first drive coil, whereby a first detection signal based on a distance between the first drive coil and the first detectable coil is generated. Similarly, an induced current is generated in the second detectable coil by a magnetic field generated by the second drive coil, whereby a second detection signal based on a distance between the second drive coil and the second detectable coil is generated. Accordingly, a position each of the first movable member and the second movable member can be detected.

Further, an induced current generated by the third driver and the fourth driver of the second drive coil is cancelled out by a magnetic field generated by the first drive coil. An induced current generated by the third portion and the fourth portion of the second detectable coil is cancelled out by a magnetic field generated by the first drive coil. Similarly, an induced current generated by the first driver and the second driver of the first drive coil is cancelled out by a magnetic field generated by the second drive coil. An induced current generated by the first portion and the second portion of the first detectable coil is cancelled out by a magnetic field generated by the second drive coil.

As described above, influence of the magnetic field between a pair of the first drive coil and the first detectable coil (hereinafter, a “first coil pair”) and a pair of the second drive coil and the second detectable coil (hereinafter, a “second coil pair”) is reduced. Therefore, even in a configuration in which the first movable member and the second movable member are close to each other, it is possible to generate a first detection signal and a second detection signal reflecting a position of the first movable member and a position of the second movable member, respectively, with high accuracy. Furthermore, since the influence of the magnetic field is reduced between the first coil pair and the second coil pair, it is possible to enhance a magnetic field generated by the first drive coil and the second drive coil. Therefore, it is possible to detect positions each of the first movable member and the second movable member over a wide range.

The “(first/second) movable member” is a movable member. For example, a control or an operator that moves in response to an operation by a user is exemplified as a “movable member.” Specifically, a member that moves in response to a playing operation by a user is an example of a “movable member.” For example, in addition to a playing operation (for example, a key of a keyboard musical instrument) directly carried out by a user, a sound generating mechanism (for example, a hammer) that moves in conjunction with the playing operation is exemplified as a “movable member.”

The “first direction” and the “second direction” are directions opposite to each other. A magnetic field generated by a current in the first direction and a magnetic field generated by a current in the second direction are opposite to each other. The first direction and the second direction are not limited to a particular direction. That is, the first direction and the second direction may be periodically reversed, for example, while maintaining an opposite relationship to each other.

In an example (Aspect 2) of Aspect 1, the first movable member and the second movable member are disposed adjacent to each other in a specific direction, the first driver and the third driver are disposed adjacent to each other in the specific direction, the second driver and the fourth driver are disposed adjacent to each other in the specific direction, the first portion and the third portion are disposed adjacent to each other in the specific direction, and the second portion and the fourth portion are disposed adjacent to each other in the specific direction. In the above aspect, it is possible to specify with high accuracy the closely proximate positions of the first movable member and the second movable member that are adjacent to each other.

scenario In an example (Aspect 3) of Aspect 1 or Aspect 2, the detection system further includes a drive circuit configured to drive each of the first signal generator and the second signal generator, in which the drive circuit is configured to supply a first drive signal to the first signal generator during a first drive period, and a second drive signal to the second signal generator during a second drive period different from the first drive period. In the above aspect, the first signal generator and the second signal generator are driven during different drive periods. Therefore, compared with a configuration in which the first signal generator and the second signal generator are driven in parallel, the influence of the magnetic field between the first coil pair and the second coil pair can be further reliably reduced.

The “(first/second) drive signal” is a periodic signal for generating a magnetic field in the drive coil. The first drive signal and the second drive signal may be the same or differ from each other. For example, a signal having the same characteristic, such as amplitude or period, may be used both as the first drive signal and the second drive signal. Alternatively, an amplitude of the first drive signal and that of the second drive signal may differ from each other.

In an example (Aspect 4) of Aspect 1 or Aspect 2, the detection system further includes a drive circuit configured to drive each of the first signal generator and the second signal generator, in which the drive circuit is configured to concurrently supply a first drive signal to the first signal generator and a second drive signal to the second signal generator during a drive period. In the above aspect, the first signal generator and the second signal generator are driven in parallel or concurrently. Therefore, compared with a configuration in which the first signal generator and the second signal generator are driven during different drive periods, an advantage is obtained in that it is easy to secure a time in which to drive the first signal generator and the second signal generator.

In an example (Aspect 5) of any one of Aspects 1 to 4, the detection system further includes a position analyzer configured to specify a position of the first movable member based on a signal level of the first detection signal and a position of the second movable member based on a signal level of the second detection signal, in which a relationship between the signal level of the first detection signal and the first movable member differs from a relationship between the signal level of the second detection signal and the second movable member. In the above aspect, a relationship between the signal level of the first detection signal and the position of the first movable member differs from a relationship between the signal level of the second detection signal and the position of the second movable member. Therefore, in a configuration in which the signal level of the first detection signal differs from the signal level of the second detection signal, with the first movable member and the second movable member at the same position, it is possible to specify with high accuracy the positions of the first movable member and the second movable member.

The detection system according to an example (Aspect 6) of any one of Aspects 1 to 5 includes a first resonant circuit that includes the first detectable coil and a first capacitive element; and a second resonant circuit that includes the second detection coil and a second capacitive element. In this aspect, the first detectable coil and the first capacitive element constitute a first resonant circuit, and the second detectable coil and the second capacitive element constitute a second resonant circuit. Therefore, the positions of the first movable member and the second movable member can be specified with high accuracy.

In an example (Aspect 7) of Aspect 6, the first resonant circuit further includes a first resistive element connected to the first detectable coil. The relationship (position-level characteristics) between the position of the first movable member and the signal level of the first detection signal may differ from the relationship (position-level characteristics) between the position of the second movable member and the signal level of the second detection signal. By appropriately selecting the resistance value of the first resistive element, the position-level characteristics between the first movable member and the second movable member can be made sufficiently close (ideally matched) to each other.

In an example (Aspect 8) of Aspect 6 or Aspect 7, the second resonant circuit further includes a second resistive element connected to the second detectable coil. The relationship (position-level characteristics) between the position of the first movable member and the signal level of the first detection signal may differ from the relationship (position-level characteristic) between the position of the second movable member and the signal level of the second detection signal. By appropriately selecting the resistance value of the second resistive element, the position-level characteristics between the first movable member and the second movable member can be made sufficiently close (ideally matched) to each other.

A musical instrument according to one aspect (Aspect 9) of the present disclosure includes a first movable member and a second movable member that move in response to a playing operation of a user; a first detectable coil disposed on the first movable member; a second detectable coil disposed on the second movable member; a first signal generator, including a first drive coil that faces the first detectable coil, configured to generate a first detection signal based on a distance between the first detectable coil and the first drive coil; and a second signal generator, including a second drive coil that faces the second detectable coil, configured to generate a second detection signal based on a distance between the second detectable coil and the second drive coil. The first drive coil includes: a first driver through which current flows in a first direction; and a second driver through which current flows in a second direction opposite to the first direction. The second drive coil includes: a third driver through which current flows in the first direction; and a fourth driver through which current flows in the first direction. The first detectable coil includes a first portion and a second portion where induced currents in directions opposite to each other are generated by electromagnetic induction of the first drive coil, and the second detectable coil includes a third portion and a fourth portion where induced currents in a same direction as each other are generated by electromagnetic induction of the second drive coil.

### DESCRIPTION OF REFERENCE SIGNS

100 . . . keyboard musical instrument, 20 . . . keyboard unit, 21 . . . keyboard, 22 . . . key, 22a . . . first key, 22b . . . second key, 23 . . . balance pin, 24 . . . support, 25 . . . detection system, 30 . . . control system, 31 . . . control device, 32 . . . storage device, 33. . . . A/D converter, 34 . . . sound source circuit, 40 . . . sound emitting system, 50 . . . signal generator, 50a . . . first signal generator, 50b . . . second signal generator, 60 . . . detectable portion, 60a . . . first detectable portion, 60b . . . second detectable portion, 70 . . . drive circuit, 71 . . . supply circuit, 72 output circuit.

1. A detection system comprising:
a first detectable coil disposed on a first movable member;
a second detectable coil disposed on a second movable member;
a first signal generator, including a first drive coil that faces the first detectable coil, configured to generate a first detection signal based on a distance between the first detectable coil and the first drive coil; and
a second signal generator, including a second drive coil that faces the second detectable coil, configured to generate a second detection signal based on a distance between the second detectable coil and the second drive coil,
wherein the first drive coil includes:
a first driver through which current flows in a first direction; and
a second driver through which current flows in a second direction opposite to the first direction,
wherein the second drive coil includes:
a third driver through which current flows in the first direction; and
a fourth driver through which current flows in the first direction,
wherein the first detectable coil includes a first portion and a second portion where induced currents in directions opposite to each other are generated by electromagnetic induction of the first drive coil, and
wherein the second detectable coil includes a third portion and a fourth portion where induced currents in a same direction as each other are generated by electromagnetic induction of the second drive coil.

2. The detection system according to claim 1, wherein:
the first movable member and the second movable member are disposed adjacent to each other in a specific direction,
the first driver and the third driver are disposed adjacent to each other in the specific direction,
the second driver and the fourth driver are disposed adjacent to each other in the specific direction,
the first portion and the third portion are disposed adjacent to each other in the specific direction, and
the second portion and the fourth portion are disposed adjacent to each other in the specific direction.

3. The detection system according to claim 1, further comprising:
a drive circuit configured to drive each of the first signal generator and the second signal generator,
wherein the drive circuit is configured to supply:
a first drive signal to the first signal generator during a first drive period; and
a second drive signal to the second signal generator during a second drive period different from the first drive period.

4. The detection system according to claim 1, further comprising:
a drive circuit configured to drive each of the first signal generator and the second signal generator,
wherein the drive circuit is configured to concurrently supply a first drive signal to the first signal generator and a second drive signal to the second signal generator during a drive period.

5. The detection system according to claim 1, further comprising:
a position analyzer configured to specify:
a position of the first movable member based on a signal level of the first detection signal; and
a position of the second movable member based on a signal level of the second detection signal,
wherein a relationship between the signal level of the first detection signal and the first movable member differs from a relationship between the signal level of the second detection signal and the second movable member.

6. The detection system according to claim 1, further comprising:
a first resonant circuit that includes the first detectable coil and a first capacitive element; and
a second resonant circuit that includes the second detectable coil and a second capacitive element.

7. The detection system according to claim 6, wherein the first resonant circuit further includes a first resistive element connected to the first detectable coil.

8. The detection system according to claim 6, wherein the second resonant circuit further includes a second resistive element connected to the second detectable coil.

9. A musical instrument comprising:
a first movable member and a second movable member that move in response to a playing operation of a user;
a first detectable coil disposed on the first movable member;
a second detectable coil disposed on the second movable member;
a first signal generator, including a first drive coil that faces the first detectable coil, configured to generate a first detection signal based on a distance between the first detectable coil and the first drive coil; and
a second signal generator, including a second drive coil that faces the second detectable coil, configured to generate a second detection signal based on a distance between the second detectable coil and the second drive coil,
wherein the first drive coil includes:
a first driver through which current flows in a first direction; and
a second driver through which current flows in a second direction opposite to the first direction,
wherein the second drive coil includes:
a third driver through which current flows in the first direction; and
a fourth driver through which current flows in the first direction,
wherein the first detectable coil includes a first portion and a second portion where induced currents in directions opposite to each other are generated by electromagnetic induction of the first drive coil, and
wherein the second detectable coil includes a third portion and a fourth portion where induced currents in a same direction as each other are generated by electromagnetic induction of the second drive coil.
